(19) United States
(12) Patent Application Publication
(10) Pub. No.: US 2024/0164400 A1
(43) Pub. Date: May 23, 2024

(54) CHOCOLATE CONTAINING MEDIUM-CHAIN-BOUND TRIGLYCERIDE

(71) Applicant: FUJI OIL HOLDINGS INC., Osaka (JP)

(72) Inventors: Yurina TOBA, Ibaraki (JP); Sachiko INUI, Ibaraki (JP)

(73) Assignee: FUJI OIL HOLDINGS INC., Osaka (JP)

(21) Appl. No.: 18/282,794

(22) PCT Filed: Mar. 24, 2022
(86) PCT No.: PCT/JP2022/013868

§ 371 Date: Sep. 19, 2023

(30) Foreign Application Priority Data
Mar. 30, 2021 (JP) 2021-057951

(51) Int. Cl. A23G 1/36; A23G 1/46

(52) U.S. Cl. CPC A23G 1/36; A23G 1/46

(57) ABSTRACT

The present invention is to improve a texture of a chocolate containing 15 wt. % or more of a non-fat milk solid content because such a chocolate exhibits significant stickiness when chewed and/or swallowed. The problem is solved by adding 0.85 wt. % or more of a medium-chain-bound triglyceride in the chocolate, the medium-chain-bound triglyceride being derived from a randomized oil and/or fat. With such a chocolate, the stickiness can be reduced and a clean texture can be achieved.

### TECHNICAL FIELD

The present invention relates to a chocolate containing an oil and/or fat as a continuous layer.

### BACKGROUND ART

In general, when a chocolate melts in the mouth, its characteristic melting is due to the fact that an oil and/or fat contained in chocolate dough has a characteristically quick melting behavior at around the body temperature. However, at the same time, a melted chocolate exhibits high stickiness and tends to stick to the wall of the oral cavity, causing an unpleasant lingering aftertaste feeling. In the present application, this is expressed as stickiness during chewing and swallowing.

Patent Document 1 discloses a texture improving agent for a tempering-type chocolate, where the texture improving agent contains a vegetable oil and/or fat containing 25 to 50% of lauric acid based on a total fatty acid composition, 5 to 30% of SOS-type triglyceride (S: saturated fatty acid, O: oleic acid), and a lipophilic sorbitan fatty acid ester, for the purpose of significantly reducing stickiness of a chocolate eluted in saliva and thus providing a chocolate having a refreshing feeling with little unpleasant lingering aftertaste in the mouth, which has been difficult in the related art, while exhibiting quick melting behavior of a known chocolate in the mouth.

Patent Document 2 addresses the problem that white chocolate and milk chocolate have a composition mainly composed of cacao butter and whole milk powder and such a composition emphasizes the taste of milk components, thereby adversely affecting the aftertaste. To solve this problem, the Patent Document 2 discloses a technique of inclusion of polyphenols for the purpose of improving the aftertaste and giving a mellow and clean aftertaste and sharpness of taste.

Patent Document 3 discloses a technique of inclusion of a medium-chain-bound triglyceride in a specific amount or more to reduce a powdery texture of a chocolate containing a large amount of non-fat cacao solids.

### PRIOR ART DOCUMENTS

### Patent Documents

Patent Document 1: JP H09-121771 A
Patent Document 2: JP 2005-6503 A
Patent Document 3: JP 2018-191637 A

### DISCLOSURE OF THE INVENTION

### Technical Problem

The technique described in Patent Document 1 has a problem in that it is necessary to reduce stickiness of the chocolate to reduce the sticking of the chocolate inside the mouth, when the chocolate is eluted in saliva, and thus it is difficult to freely adjust physical properties of the chocolate.

Patent Document 2 describes that blending a polyphenol-containing composition extracted from green tea leaves to a chocolate or white chocolate is effective in improving aftertaste. However, blending of polyphenol, which is an astringent component, may lead to modification of chocolate taste.

In Patent Document 3, a medium-chain-bound triglyceride is used as a technique for improving the texture of a chocolate. However, a chocolate containing a non-fat milk solid content is not described, and the problem is also different from that of the present application.

That is, an object of the present invention is to provide a method for reducing stickiness during chewing and swallowing which is a problem particular to a chocolate containing a large amount of a non-fat milk solid content derived from powdered milk or the like.

### Solution to Problem

The present inventors have found that a chocolate containing 15 wt. % or more of a non-fat milk solid content exhibits pronounced stickiness during chewing and swallowing, and when such a chocolate contains a medium-chain-bound triglyceride produced by a randomization process such as interesterification or ester synthesis in an amount of 0.85 wt. % or more, the chocolate has reduced stickiness and acquires a non-lingering texture. Thus the present inventors have completed the present invention.

That is, the present invention relates to:
(1) a chocolate containing 0.85 to 15.0 wt. % of a medium-chain-bound triglyceride derived from a randomized oil and/or fat and 15 wt. % or more of a non-fat milk solid content, in which the medium-chain fatty acid represents a fatty acid having 6 to 10 carbons;
(2) the chocolate according to (1) containing 20 to 50 wt. % of powdered milk;
(3) the chocolate according to (1) or (2), in which the randomized oil and/or fat is a random-interesterified oil of an MCT oil and a long-chain fatty acid oil and/or fat;
(4) a method for producing a chocolate containing 15 wt. % or more of a non-fat milk solid content, the method including adding 0.85 to 15.0 wt. % of a medium-chain-bound triglyceride produced by randomization in the chocolate, in which the medium-chain fatty acid represents a fatty acid having 6 to 10 carbons;
(5) a method for improving a texture of a chocolate containing 15 wt. % or more of a non-fat milk solid content, the method including adding 0.85 to 15.0 wt. % of a medium-chain-bound triglyceride derived from a randomized oil and/or fat in the chocolate, in which the medium-chain fatty acid represents a fatty acid having 6 to 10 carbons; and
(6) a texture-improving oil and/or fat for a chocolate containing 15 wt. % or more of a non-fat milk solid content, the texture-improving oil and/or fat being a randomized oil and/or fat and containing 15 to 28 wt. % of a medium-chain-bound triglyceride, in which the medium-chain fatty acid represents a fatty acid having 6 to 10 carbons.

### Advantageous Effects of Invention

According to the present invention, it is possible to reduce stickiness of a chocolate such as white chocolate and milk chocolate, which contains a large amount of a non-fat milk solid content, and thus it is possible to produce a product that meets preferences of consumers who prefer in recent years, a non-lingering aftertaste and refreshing texture.

### DESCRIPTION OF EMBODIMENTS

Hereinafter, the present invention will be specifically described.

In the present application, a chocolate is an oil and/or fat processed food product in which an oil and/or fat forms a continuous phase, and refers to not only chocolate, quasi-chocolate, and chocolate-based food products defined by the National Chocolate Industry Fair Trade Council and the Chocolate-Based Food Fair Trade Council, but also products containing an oil and/or fat and powdered milk as essential components, in which as needed, auxiliary raw materials such as saccharides, a cacao raw material (cacao mass, cocoa, and cocoa butter), fruit juice powder, fruit powder, a flavoring agent, an emulsifier, a flavor, or a coloring agent are blended in arbitrary proportions.

Typical examples of the chocolate include milk chocolate and white chocolate. In addition, strawberry chocolate and the like produced by adding a fruit component to these are also included.

The chocolate according to an embodiment of the present invention needs to contain a non-fat milk solid content in an amount of 15 wt. % or more, preferably 16 wt. % or more, more preferably 17 wt. % or more, still more preferably 18 wt. % or more, most preferably 19 wt. % or more, and still most preferably 20 wt. % or more. When the chocolate contains the non-fat milk solid content in an amount of 15 wt. % or more, stickiness is clearly felt during eating, and thus, improvement of the texture is required.

The chocolate according to an embodiment of the present invention preferably contains 20 to 50 wt. %, more preferably 23 to 40 wt. % of powdered milk.

Here, the non-fat milk solid content is a solid content produced by removing milk fat from a component derived from powdered milk such as whole milk powder or fat-free milk powder.

The chocolate according to an embodiment of the present invention needs to contain 0.85 wt. % or more, preferably 0.9 wt. % or more, more preferably 0.95 wt. % or more, still more preferably 1 wt. % or more, most preferably 1.5 wt. % or more, still most preferably 5 wt. % or more, and secondly preferably 10 wt. % or more of a medium-chain-bound triglyceride derived from a randomized oil and/or fat. In addition, it contains preferably 30 wt. % or less of the medium-chain-bound triglyceride.

When the chocolate contains the medium-chain-bound triglyceride in an amount of 0.85 wt. % or more, stickiness during eating is improved.

The medium-chain-bound triglyceride of the present application is a triglyceride in which at least one constituent fatty acid is a medium-chain fatty acid. That is, the medium-chain-bound triglyceride of the present application includes a three-medium-chain-bound triglyceride and a medium-chain/long-chain mixed acid triglyceride (two-medium-chain one-long-chain triglyceride and one-medium-chain two-long-chain triglyceride).

Here, the medium-chain fatty acid is a fatty acid having 6 to 10 carbons, and the long-chain fatty acid is a fatty acid having 12 to 22 carbons.

Among the medium-chain-bound triglycerides of the present application, the medium-chain/long-chain mixed acid triglyceride has a higher effect of reducing stickiness during eating than the three-medium-chain-bound triglyceride.

In the long-chain fatty acid of the mixed acid triglyceride, a ratio of an unsaturated fatty acid to a saturated fatty acid (long-chain unsaturated/saturated) is preferably 2.5 or more, more preferably 3.0 or more, still more preferably 3.5 or more.

When the ratio of the unsaturated fatty acid to the saturated fatty acid is 2.5 or more, stickiness during eating is further reduced, which is preferable.

The randomized oil and/or fat from which the medium-chain-bound triglyceride according to an embodiment of the present invention is derived can be prepared by random interesterification or ester synthesis. Typically, a random-interesterified oil and an ester-synthesized oil have a random distribution of fatty acids on a triglyceride molecule.

As the random interesterification reaction of an oil and/or fat, a method using sodium methylate, sodium ethylate, an alkali metal such as sodium, sodium hydroxide, potassium hydroxide, or the like as a catalyst is known, but sodium methylate is preferably used from the viewpoint of a reaction temperature, a reaction time, and ease of handling. Furthermore, as an enzymatic method, a method using an oil and/or fat decomposing enzyme (lipase) as a catalyst is also known. Any method may be used.

The ester synthesis reaction of an oil and/or fat is a method for producing an oil and/or fat in which a fatty acid and glycerin are subjected to dehydration condensation under a reduced pressure condition, and is used for production of, for example, an MCT oil (medium-chain fatty acid oil and/or fat).

The medium-chain-bound triglyceride of the present application is derived from a randomized oil and/or fat, and thus, fatty acids are randomly distributed on the triglyceride molecule. For example, in a case of a two-medium-chain one-long-chain triglyceride, an abundance ratio between MLM and MML is 1:2 (M: medium chain, L: long chain). Furthermore, for example, in a three-medium-chain-bound triglyceride in which two fatty acids each having 8 carbons and one fatty acid having 10 carbons are bound, an abundance ratio of C8C10C8 to C8C8C10 is 1:2.

As described above, the medium-chain-bound triglyceride of the present application needs to have random distribution.

Among the medium-chain-bound triglycerides of the present application, the medium-chain/long-chain mixed acid triglyceride is produced by random interesterification between an MCT oil and a long-chain fatty acid oil and/or fat. The long-chain fatty acid oil and/or fat is preferably a liquid oil mainly containing an unsaturated fatty acid having 18 carbons.

The liquid oil is an oil and/or fat which is liquid at room temperature and contains an unsaturated fatty acid having 18 carbons as a main component in constituent fatty acids. Examples of the liquid oil include rapeseed oil, soybean oil, corn oil, safflower oil, cottonseed oil, sunflower oil, and palm oil. Further examples thereof include processed oils and fats which are liquid at room temperature and produced by subjecting these oils and fats to one or two or more physical or chemical treatments such as hydrogenation, fractionation, and interesterification. As the liquid oil of the present invention, corn oil and sunflower oil are preferably used, and corn oil is more preferably used.

In the random interesterification between the MCT oil and the long-chain fatty acid oil and/or fat, an amount of the MCT oil in the raw material is preferably 2 to 20 wt. %, more preferably 3 to 15 wt. %, further preferably 3.5 to 10 wt. %, and still further preferably 4.0 to 7 wt. %.

The randomized oil and/or fat from which the medium-chain-bound triglyceride of the present invention is derived can also be regarded as a texture-improving oil and/or fat for a chocolate. The texture-improving agent according to an embodiment of the present invention needs to contain the medium-chain-bound triglyceride in an amount of 15 to 28 wt. %, preferably 17 to 25 wt. %. The texture-improving agent preferably contains the medium-chain fatty acid in an amount of 4 to 7 wt. % in the constituent fatty acids, and preferably has an SFC at 20° C. of 3% or less.

The chocolate according to an embodiment of the present invention may be of a tempering type or a non-tempering type.

### INDUSTRIAL APPLICABILITY

According to an embodiment of the present invention, the texture of chocolates containing a large amount of a non-fat milk solid content, such as white chocolate and milk chocolate, is improved, and thus, expansion of consumption can be expected.

### Examples

Examples will be described below, but the technical idea of the present invention is not limited to these examples. Note that in the examples, values in “part” or “%” are all expressed by weight.
Preparation of oil and/or fat for chocolate blending

### (Interesterified Oil 1)

An oil and/or fat produced by mixing 95 parts of corn oil and 5 parts of an MCT oil (trade name: MCT-64, available from Fuji Oil Co., Ltd.) was used as a raw material to perform interesterification using sodium methylate, and the produced oil and/or fat was purified in accordance with a common method to produce a interesterified oil 1.

### (Interesterified Oil 2)

An oil and/or fat produced by mixing 82 parts of corn oil, 5 parts of an MCT oil (trade name: MCT-64, available from Fuji Oil Co., Ltd.), 5 parts of high oleic sunflower oil, and 8 parts of highly hydrogenated high oleic sunflower oil was used as a raw material to perform interesterification using sodium methylate to produce a interesterified oil 2.

### (Corn Oil)

Corn oil was used.

### (Mct Oil)

An MCT oil (trade name: MCT-64, available from Fuji Oil Co., Ltd.) was used.

### (Palm Super Olein)

Palm super olein (iodine value of 67, trade name: Palm Ace 10, available from Fuji Oil Co., Ltd.) was used.

Triglyceride compositions of the oil and/or fat compositions described above are shown in Table 1.
Three-medium-chain-bound triglyceride (sum of C24 to 30)
Two-medium-chain one-long-chain triglyceride (sum of C32 to 38)
One-medium-chain two-long-chain triglyceride (sum of C40 to 46)
Medium-chain-bound triglyceride which is the total amount of the above three (sum of C24 to 46)

The medium-chain and long-chain fatty acid contents and a solid fat index (SFC) in the constituent fatty acids are shown in Table 2.

TABLE 1

| | Each triglyceride content (%) in oil and/or fat | | | | | | |
|---|---|---|---|---|---|---|---|
| | | | | Medium-chain | Proportion (%) in medium-chain-bound triglyceride | | |
| | Three- | Two-medium- | One-medium- | fatty acid- | | | One-medium- |
| | medium- | chain one-long- | chain two- | containing | Three- | Two-medium-chain | chain two-long- |
| | chain | chain | long-chain | triglyceride | medium-chain | one-long-chain | chain |
| Interesterified | 0.0 | 4.0 | 17.4 | 21.4 | 0.0 | 18.7 | 81.3 |
| oil 1 | | | | | | | |
| Interesterified | 0.0 | 3.7 | 17.8 | 21.6 | 0.0 | 17.1 | 82.4 |
| oil 2 | | | | | | | |
| Corn oil | 0.0 | 0.0 | 0.0 | 0.0 | | | |
| MCT oil | 100.0 | 0.0 | 0.0 | 100.0 | 100.0 | 0.0 | 0.0 |
| Palm super olein | 0.0 | 0.0 | 0.0 | 0.0 | | | |

TABLE 2

| | Constituent fatty acid in oil and/or fat | | | | | | |
|---|---|---|---|---|---|---|---|
| | Medium-chain | Unsaturated fatty acid | Saturated fatty acid | | | | |
| | fatty acid | having 16 to 22 | having 16 to 22 | (Unsaturated/saturated) ratio of | SFC % | | |
| | content (%) | carbons (%) | carbons (%) | fatty acids having 16 to 22 carbons | 0° C. | 5° C. | 10° C. |
| Interesterified oil 1 | 5.0 | 81.1 | 12.6 | 6.4 | 3.1 | 1.9 | 0.8 |
| Interesterified oil 2 | 5.0 | 75.1 | 20.0 | 3.8 | 8.7 | 6.4 | 4.2 |
| Corn oil | 0.0 | 85.3 | 13.3 | 6.4 | 0.0 | 0.0 | 0.1 |
| MCT oil | 100.0 | 0.0 | 0.0 | | 0.1 | 0.0 | 0.2 |
| Palm super olein | 0.0 | 63.1 | 35.7 | 1.8 | 4.5 | 0.2 | 0.0 |

Test A
   White chocolate dough was produced in accordance with a common method based on the formulation shown in Table 3 using the blending oil and/or fat prepared above.
   After the chocolate dough was melted at 50° C. or higher, the temperature was lowered to 31° C. while cooling with cold water at 13° C.
   A seed agent (available from Fuji Oil Co., Ltd./trade name “CHOCO SEED A”) was added in an amount of 0.2 wt. % with respect to the amount of the chocolate, and the produced chocolate dough was tempered and poured into a mold.
   Cooling was performed at 10° C. for 30 minutes and demolding was performed.
   Aging was performed at 20° C. for one week to prepare each chocolate.
   The non-fat milk solid content and the content of medium-chain-bound triglyceride derived from the blending oil and/or fat in each chocolate are shown in Table 3.
   Seven well-trained panelists who were engaged in the development of chocolate oils and fats evaluated the stickiness of the prepared chocolate during chewing and swallowing according to the following evaluation criteria. The sensory evaluation results are shown in Table 3.
      Evaluation of stickiness during chewing and swallowing (score 3 or higher was regarded as acceptable)
Score 1 Strong stickiness is felt during chewing.
Score 2 Slight stickiness is felt during chewing.
Score 3 Slight stickiness is felt during chewing, but this is within an acceptable range.
Score 4 No stickiness is felt during chewing.
Score 5 No stickiness is felt during chewing, and a non-lingering aftertaste is felt during swallowing.

TABLE 3

| | | | Comparative | Comparative | Comparative |
|---|---|---|---|---|---|
| Formulation (parts by weight) | Example 1 | Example 2 | Example 1 | Example 2 | Example 3 |
| Whole milk powder (oil content 26%) | 23.8 | 23.8 | 23.8 | 23.8 | 23.8 |
| Sugar | 37.2 | 37.2 | 37.2 | 37.2 | 37.2 |
| Cocoa butter | 23.8 | 23.8 | 23.8 | 23.8 | 23.8 |
| Interesterified oil 1 | 15.0 | | | | |
| MCT oil | | 15.0 | 0.75 | | |
| Corn oil | | | 14.25 | 15.0 | |
| Palm super olein | | | | | 15.0 |
| Lecithin | 0.2 | 0.2 | 0.2 | 0.2 | 0.2 |
| Content in chocolate | | | | | |
| Non-fat milk solid content (%) | 17.6 | 17.6 | 17.6 | 17.6 | 17.6 |
| Medium-chain fatty acid-containing triglyceride | 3.2 | 15.0 | 0.8 | 0.0 | 0.0 |
| (%) derived from blending oil and/or fat | | | | | |
| Total oil content (%) | 45 | 45 | 45 | 45 | 45 |
| Evaluation result | | | | | |
| Stickiness during chewing and swallowing | 5 | 5 | 2 | 2 | 1 |

In the white chocolate having a non-fat milk solid content of 17.6 wt. %, Comparative Example 2 and Comparative Example 3 which contained no medium-chain-bound triglyceride were both evaluated as Score 1 or 2 in the sensory evaluation, which were unacceptable.

On the other hand, the chocolate of Example 1 using the interesterified oil 1 of corn oil and the MCT oil contained 3.2 wt. % of the medium-chain-bound triglyceride, and exhibited a good texture of Score 5.

Furthermore, the chocolate of Example 2 using the MCT oil contained a large amount of the medium-chain-bound triglyceride of 15 wt. % and was evaluated as Score 5 which was good. However, although a larger amount of the medium-chain-bound triglyceride was contained as compared with Example 1, the texture evaluation was equivalent, and it was considered that the interesterified oil 1 was superior to the MCT oil in terms of potency for improvement of stickiness.

The chocolate of Comparative Example 1 uses corn oil and the MCT oil. On the other hand, the raw materials before the reaction of the interesterified oil 1 used in Example 1 are corn oil and the MCT oil in the same amounts. Difference between them is only a point of being randomized or not, but the chocolate of Example 1 was acceptable at Score 5, and the chocolate of Comparative Example 1 was unacceptable at Score 2. It can be seen that there is clear difference in the effect of reducing stickiness by randomization even with the same raw material oil and/or fat.
Test B
   White chocolate of Example 3 was prepared in the same manner as in Test A except that the interesterified oil 1 was used as the blending oil and/or fat to produce chocolate dough (oil content of 45%) in accordance with a common method based on the formulation shown in Table 4, and the texture was evaluated.

TABLE 4

| Formulation (parts) | Example 3 |
|---|---|
| Whole milk powder (oil content 26%) | 23.8 |
| Sugar | 37.2 |
| Cocoa butter | 23.8 |
| Palm mid-melting point oil and/or fat (iodine value 45) | 7.5 |
| interesterified oil 1 | 7.5 |
| Lecithin | 0.2 |
| Content in chocolate | |
| Non-fat milk solid content (%) | 17.6 |
| Medium-chain fatty acid-containing triglyceride | 1.6 |
| (%) derived from blending oil and/or fat | |
| Total oil content (%) | 45 |

The chocolate of Example 3 in which the interesterified oil 1 was used was good because no stickiness was felt during chewing.
Test C
   Chocolate was prepared in the same manner as in Test A except that the interesterified oil 1 and the interesterified oil 2 were used as the blending oil and/or fat to produce strawberry chocolate dough (oil content of 41.1%) in accordance with a common method based on the formulation shown in Table 5, and the texture was evaluated.

TABLE 5

| Formulation (parts) | Example 4 | Example 5 |
|---|---|---|
| Whole milk powder (oil content 26%) | 24.7 | 24.7 |
| Sugar | 38.8 | 38.8 |
| Cocoa butter | 24.6 | 24.6 |
| FD strawberry | 1.6 | 1.6 |
| Interesterified oil 1 | 10.0 | |
| Interesterified oil 2 | | 10.0 |
| Lecithin | 0.3 | 0.3 |
| Content in chocolate | | |
| Non-fat milk solid content (%) | 18.3 | 18.3 |
| Medium-chain fatty acid-containing | 2.1 | 2.2 |
| triglyceride (%) derived from | | |
| blending oil and/or fat | | |
| Total oil content (%) | 41.1 | 41.1 |

The strawberry chocolate of Example 4 in which the interesterified oil 1 was used was good because no stickiness was felt during chewing. The strawberry chocolate of Example 5 in which the interesterified oil 2 was used was similar, but exhibited slightly inferior texture to that of Example 4.

The (unsaturated/saturated) ratio of fatty acids having 16 to 22 carbons of the interesterified oil 2 used in Example 5 was 3.8, which was lower than 5.7 of the interesterified oil 1, and it was suggested that this may be caused by a small amount of unsaturated fatty acids having 16 to 22 carbons.
Test D

It is examined how much the chocolate should contain the medium-chain-bound triglyceride to exhibit a desired effect.

Chocolates were prepared in the same manner as in Test A except that palm super olein and the interesterified oil 1 were used as the blending oil and/or fat to produce white chocolate doughs of Examples 6 and 7 and Comparative Examples 6 and 7 in accordance with a common method based on the formulation shown in Table 6, and the textures were evaluated.

TABLE 6

| | Comparative | Comparative | | |
|---|---|---|---|---|
| Formulation (parts) | Example 6 | Example 7 | Example 6 | Example 7 |
| Whole milk powder (oil content 26%) | 25.2 | 25.2 | 25.2 | 25.2 |
| Sugar | 39.4 | 39.4 | 39.4 | 39.4 |
| Cocoa butter | 25.2 | 25.2 | 25.2 | 25.2 |
| Tempering type hard butter | 5.0 | 5.0 | 5.0 | 5.0 |
| Palm super olein | 5.0 | 2.5 | 1.0 | 0.0 |
| Interesterified oil 1 | 0.0 | 2.5 | 4.0 | 5.0 |
| Lecithin | 0.25 | 0.25 | 0.25 | 0.25 |
| Content in chocolate | | | | |
| Non-fat milk solid content (%) | 18.7 | 18.7 | 18.7 | 18.7 |
| Medium-chain fatty acid- | 0.0 | 0.5 | 0.9 | 1.1 |
| containing triglyceride (%) derived | | | | |
| from blending oil and/or fat | | | | |
| Total oil content (%) | 41.8 | 41.8 | 41.8 | 41.8 |
| Evaluation result | | | | |
| Stickiness during chewing and | 1 | 1 | 3 | 5 |
| swallowing | | | | |

“Melano SS600” available from Fuji Oil Co., Ltd. was used as the tempering type hard butter. Melano SS600 is an oil and/or fat containing StOSt triglyceride as a main component.

The chocolates of Comparative Examples 6 and 7, respectively containing 0.0 and 0.5 wt. % of the medium-chain-bound triglyceride, were evaluated as Score 1 in the sensory evaluation, which were unacceptable.

On the other hand, the chocolate of Example 7 containing 1.1 wt. % of the medium-chain-bound triglyceride showed a good texture of Score 5, which was acceptable. The chocolate of Example 6 containing 0.9 wt. % of the medium-chain-bound triglyceride showed a texture in the acceptable range of Score 3, which was acceptable.
Test E

A relationship between an effect of imparting a non-lingering aftertaste by the medium-chain-bound triglyceride and a non-fat milk solid content in chocolate is examined.

Palm super olein and the interesterified oil 1 were used as the blending oil and/or fat to prepare white chocolate or milk chocolate having various non-fat milk solid contents in accordance with a common method based on the formulation in Table 7 in the same manner as in Test A, and the textures were evaluated. The results are shown in Table 7.

TABLE 7

| | Compara- | | | | | | | | | |
|---|---|---|---|---|---|---|---|---|---|---|
| Formulation | tive | Example | Comparative | Example | Comparative | Comparative | Comparative | Comparative | Comparative | Comparative |
| (parts) | Example 8 | 8 | Example 9 | 9 | Example 10 | Example 11 | Example 12 | Example 13 | Example 14 | Example 15 |
| Whole milk | 25.2 | 25.2 | 22.2 | 22.2 | 19.4 | 19.4 | 11.6 | 11.6 | 0.0 | 0.0 |
| powder (oil | | | | | | | | | | |
| content 26%) | | | | | | | | | | |
| Sugar | 39.4 | 39.4 | 39.5 | 39.5 | 39.6 | 39.6 | 40.8 | 40.8 | 42.6 | 42.6 |
| Cocoa mass | 0.0 | 0.0 | 9.5 | 9.5 | 17.4 | 17.4 | 24.9 | 24.9 | 36.2 | 36.2 |
| Cocoa butter | 25.2 | 25.2 | 18.4 | 18.4 | 13.1 | 13.1 | 12.1 | 12.1 | 10.7 | 10.7 |
| Tempering | 5.0 | 5.0 | 5.0 | 5.0 | 5.0 | 5.0 | 5.0 | 5.0 | 5.0 | 5.0 |
| type hard | | | | | | | | | | |
| butter | | | | | | | | | | |
| Palm super | 5.0 | 0.0 | 5.0 | 0.0 | 5.0 | 0.0 | 5.0 | 0.0 | 5.0 | 0.0 |
| olein | | | | | | | | | | |
| Interes- | 0.0 | 5.0 | 0.0 | 5.0 | 0.0 | 5.0 | 0.0 | 5.0 | 0.0 | 5.0 |
| terified | | | | | | | | | | |
| oil 1 | | | | | | | | | | |
| Lecithin | 0.25 | 0.25 | 0.45 | 0.45 | 0.45 | 0.45 | 0.45 | 0.45 | 0.45 | 0.45 |
| Content in | | | | | | | | | | |
| chocolate | | | | | | | | | | |
| Non-fat milk | 18.7 | 18.7 | 16.4 | 16.4 | 14.4 | 14.4 | 8.6 | 8.6 | 0.0 | 0.0 |
| solid content | | | | | | | | | | |
| (%) | | | | | | | | | | |
| Medium- | 0.0 | 1.1 | 0.0 | 1.1 | 0.0 | 1.1 | 0.0 | 1.1 | 0.0 | 1.1 |
| chain fatty | | | | | | | | | | |
| acid- | | | | | | | | | | |
| containing | | | | | | | | | | |
| triglyceride | | | | | | | | | | |
| (%) derived | | | | | | | | | | |
| from | | | | | | | | | | |
| blending | | | | | | | | | | |
| oil and/or fat | | | | | | | | | | |
| Total oil | 41.8 | 41.8 | 41.2 | 41.2 | 40.8 | 40.8 | 40.8 | 40.8 | 40.8 | 40.8 |
| content (%) | | | | | | | | | | |
| Evaluation | | | | | | | | | | |
| result | | | | | | | | | | |
| Stickiness | 1 | 5 | 1 | 4 | 3 | 3 | 4 | 4 | 5 | 5 |
| during | | | | | | | | | | |
| chewing and | | | | | | | | | | |
| swallowing | | | | | | | | | | |

“Melano SS600” available from Fuji Oil Co., Ltd. was used as the tempering type hard butter.

From the evaluation results of the chocolates of Comparative Examples 8, 9, 10, 12, and 14 which contain no medium-chain-bound triglyceride, it is found that when the non-fat milk solid content is high, the sensation of stickiness is emphasized. In addition, as compared with Comparative Examples 8 and 9 having non-fat milk solid contents of 18.7 wt. % and 16.4% by weight, respectively, the stickiness was improved in Examples 8 and 9 each containing the medium-chain-bound triglyceride in an amount of 1.1 wt. %.
Test F

Chocolate of Comparative Example 15 was prepared by adding milk fat instead of palm super olein in the chocolate of Comparative Example 8. As a result of the evaluation, the stickiness during chewing and swallowing was evaluated as Score 1 as in Comparative Example 8, which was unacceptable.

The milk fat contains several wt. % of medium-chain fatty acid in the constituent fatty acids, and thus, it may contain the medium-chain-bound triglyceride. However, the effect of reducing stickiness was not observed. Incidentally, the constituent fatty acids of the milk fat are not randomly distributed and the milk fat is not a randomized oil and/or fat.

1. A chocolate comprising 0.85 to 15.0 wt. % of a medium-chain fatty acid bound triglyceride derived from a randomized oil and/or fat, and 15 wt. % or more of a non-fat milk solid content, wherein the randomized oil and/or fat is a random-interesterified oil of an MCT oil and a long-chain fatty acid oil and/or fat, and the medium-chain fatty acid represents a fatty acid having 6 to 10 carbons.

2. (canceled)

3. (canceled)

4. A method for producing a chocolate containing 15 wt. % or more of a non-fat milk solid content, the method comprising adding 0.85 to 15.0 wt. % of a medium-chain fatty acid bound triglyceride produced by randomization in the chocolate, wherein the medium-chain fatty acid bound triglyceride is derived from a random-interesterified oil of an MCT oil and a long-chain fatty acid oil and/or fat, and wherein the medium-chain fatty acid represents a fatty acid having 6 to 10 carbons.

5. A method for improving a texture of a chocolate containing 15 wt. % or more of a non-fat milk solid content, the method comprising adding 0.85 to 15.0 wt. % of a medium-chain fatty acid bound triglyceride derived from a randomized oil and/or fat in the chocolate, wherein the randomized oil and/or fat is a random-interesterified oil of an MCT oil and a long-chain fatty acid oil and/or fat, and the medium-chain fatty acid represents a fatty acid having 6 to 10 carbons.

6. A texture-improving oil and/or fat for a chocolate containing 15 wt. % or more of a non-fat milk solid content, the texture-improving oil and/or fat being a randomized oil and/or fat, and comprising 15 to 28 wt. % of a medium-chain fatty acid bound triglyceride, wherein the randomized oil and/or fat is a random-interesterified oil of an MCT oil and a long-chain fatty acid oil and/or fat, and the medium-chain fatty acid represents a fatty acid having 6 to 10 carbons.

7. A chocolate comprising 0.85 to 15.0 wt. % of a medium-chain fatty acid bound triglyceride derived from a randomized oil and/or fat, 15 wt. % or more of a non-fat milk solid content, and 20 to 50 wt. % of powdered milk, wherein the randomized oil and/or fat is a random-interesterified oil of an MCT oil and a long-chain fatty acid oil and/or fat, and the medium-chain fatty acid represents a fatty acid having 6 to 10 carbons.
